(19) United States
(12) Patent Application Publication
(10) Pub. No.: US 2006/0233428 A1
(43) Pub. Date: Oct. 19, 2006

(54) Information processing apparatus and method of controlling the same

(76) Inventor: Akio Sakai, Hamura-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/397,127

(22) Filed: Apr. 4, 2006

(30) Foreign Application Priority Data
Apr. 18, 2005 (JP) 2005-120399

(51) Int. Cl. G06K 9/00

(52) U.S. Cl. 382/124

(57) ABSTRACT

According to one embodiment, an information processing apparatus includes an HDD, a fingerprint sensor, and a CPU or a BIOS-ROM which monitors a communication state between a program stored therein and the fingerprint sensor. If it is determined that the communication state is abnormal, power to the fingerprint sensor is shut off.

### CROSS-REFERENCE TO RELATED APPLICATIONS

This application is based upon and claims the benefit of priority from Japanese Patent Application No. 2005-120399, filed Apr. 18, 2005, the entire contents of which are incorporated herein by reference.

### BACKGROUND

1. Field

One embodiment of the present invention relates to an information processing apparatus and a method of controlling the same, which can properly shut off power to a fingerprint sensor if abnormal conditions occur in the fingerprint sensor or in a communication state with the fingerprint sensor.

2. Description of the Related Art

Prior art provides a countermeasure against abnormality of a fingerprint sensor, in which the power supply is monitored by an abnormality detecting section in a fingerprint data generating apparatus, and abnormal conditions of voltage are determined as abnormal conditions of the fingerprint data generating apparatus (refer to Jpn. Pat. Appln. KOKAI Pub. No. 2004-192456).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an external view of a notebook computer being an information processing apparatus according to an embodiment of the present invention.

FIG. 2 is a block diagram illustrating a system configuration of the computer.

FIG. 3 is a flowchart illustrating a method of controlling information processing to which information processing according to the present invention is applied.

FIG. 4 is a flowchart illustrating the method of controlling information processing based on a signal from an overcurrent detecting circuit of the fingerprint sensor.

### DETAILED DESCRIPTION

Various embodiments according to the invention will be described hereinafter with reference to the accompanying drawings. In general, according to one embodiment of the invention, an aspect of the present invention is an information processing apparatus comprising: internal storage means; a fingerprint sensor which detects a fingerprint image; and monitoring control means for monitoring a communication state between a program stored in the internal storage means and the fingerprint sensor, wherein the monitoring control means shuts off power to the fingerprint sensor if the monitoring control means determines that the communication state is abnormal.

An embodiment of the present invention is explained below with reference to drawings.

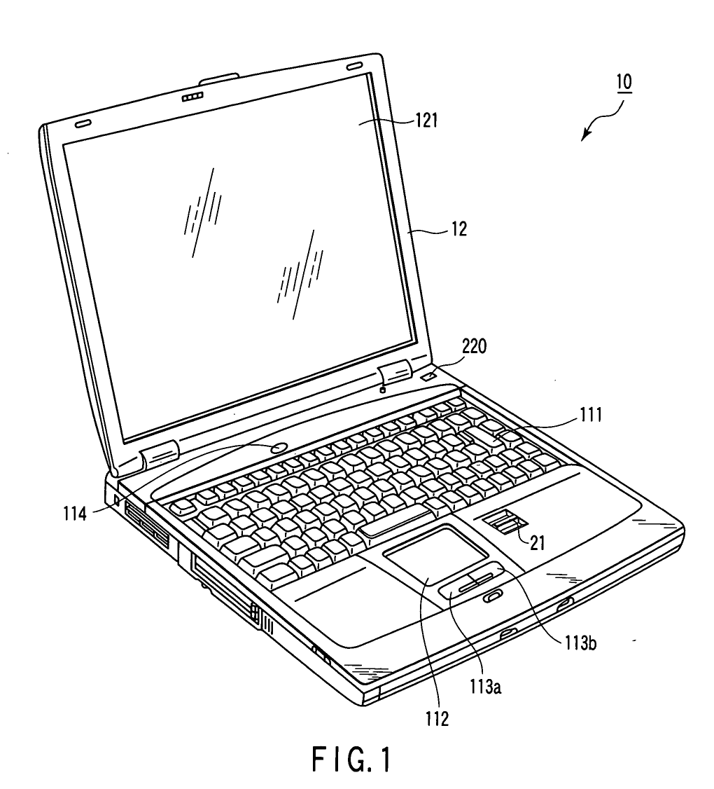

FIG. 1 is an external view of a notebook computer being an information processing apparatus according to an embodiment of the present invention.

As shown in FIG. 1, computer 10 comprises a computer main body and a display unit 12. A display device formed of an LCD (Liquid Crystal Display) is incorporated into the display unit 12. A display screen 121 of the LCD is positioned in almost the center of the display unit 12.

The display unit 12 is attached to the computer 10 such that the display unit 12 is rotatable between an open position and a closed position. The main body of the computer 10 has a thin box-shaped housing. On a top surface of the housing, provided are a power button 114, an LED indicator (indication means) 220 and a keyboard 111. Further, on a palm rest on the top surface of the housing, provided are a touch pad 112, a left and a right buttons 113a and 113b, and a fingerprint sensor 21, etc.

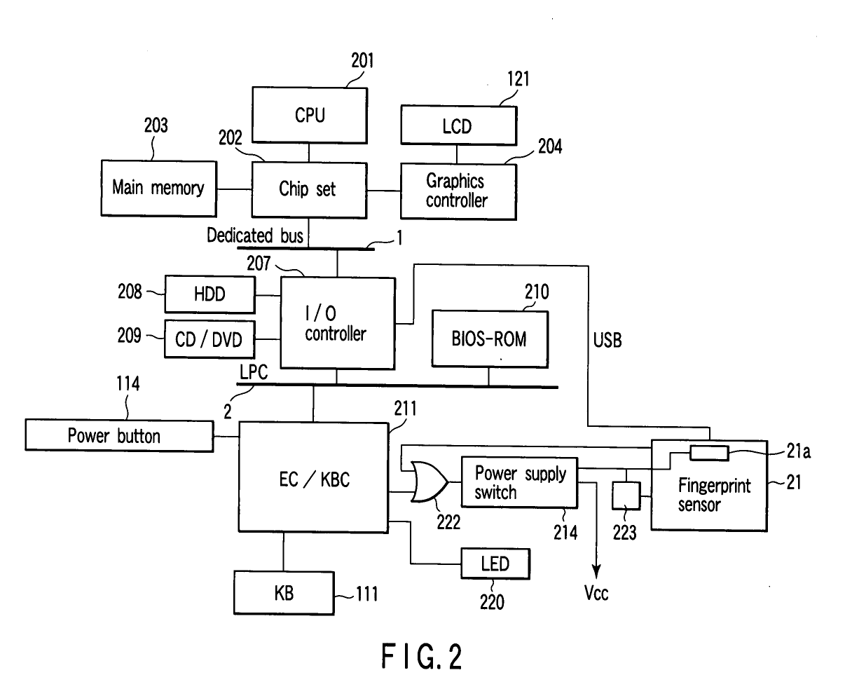

FIG. 2 is a block diagram illustrating a system configuration of the computer 10.

The computer 10 comprises a CPU 201, a chip set 202, a main memory 203, a graphics controller 204, a dedicated bus 1, an I/O controller 207, an LPC bus 2, a hard disk drive (HDD) 208, a CD/DVD drive 209, a BIOS-ROM 210, an embedded controller/keyboard controller IC (EC/KBC) 211, an OR circuit 222, a power supply switch (SW) 214, the fingerprint sensor 21, and a fingerprint sensor initializing circuit 223, etc.

The CPU 201 is a processor provided to control operation of the computer 10. The CPU 201 runs an operating system (operation system) and an application program/utility program loaded from the hard disk drive (HDD) 20 into the main memory 203. Further, the CPU 201 also executes a BIOS (Basic Input Output System) stored in the BIOS-ROM 210. The fingerprint sensor 21 has an overcurrent detecting circuit which detects overcurrent. Fingerprint authentication by the fingerprint sensor 21 is performed by a dedicated application and the like.

The chip set 202 is a bridge device which establishes a bi-directional connection between a local bus of the CPU 201 and the dedicated bus 1. The graphics controller 204 controls the display screen (display means) 121 of the LCD used as a display monitor of the computer 10. The I/O controller 207 is a PCI device, and includes an IDE controller which controls the hard disk drive (HDD) 208 and the CD/DVD drive 209, and the like.

The embedded controller/keyboard controller IC (EC/KBC) 211 is a one-chip microcomputer formed by integrating an embedded controller for electric power control and a keyboard controller which controls the keyboard 111. The embedded controller/keyboard controller IC (EC/KBC) 211 has a function of powering on and off the computer 10 in response to the operation of the power button 114 by the user, in cooperation with the power supply switch 214.

The OR circuit 222 receives a signal (for example, a signal H is outputted in the case of abnormal conditions, and a signal L in the case of normal conditions) from the overcurrent detecting circuit 21a of the fingerprint sensor 21 and a communication state abnormal signal (for example, a signal H is outputted in the case of abnormal conditions, and a signal L in the case of normal conditions) from control monitoring means and, if one of the signals indicates an abnormal condition, outputs a signal (power shutoff signal) to shut off the power to the fingerprint sensor 21 by the power supply switch 214. The control monitoring means is an application stored in the HDD 208 or the like or a BIOS program stored in the BIOS-ROM 210, and performs communications with the fingerprint sensor 21 through a USB, for example. As the hardware, the control monitoring means corresponds to the CPU 201, the BIOS-ROM 210, the chip set 202 and the main memory 203.

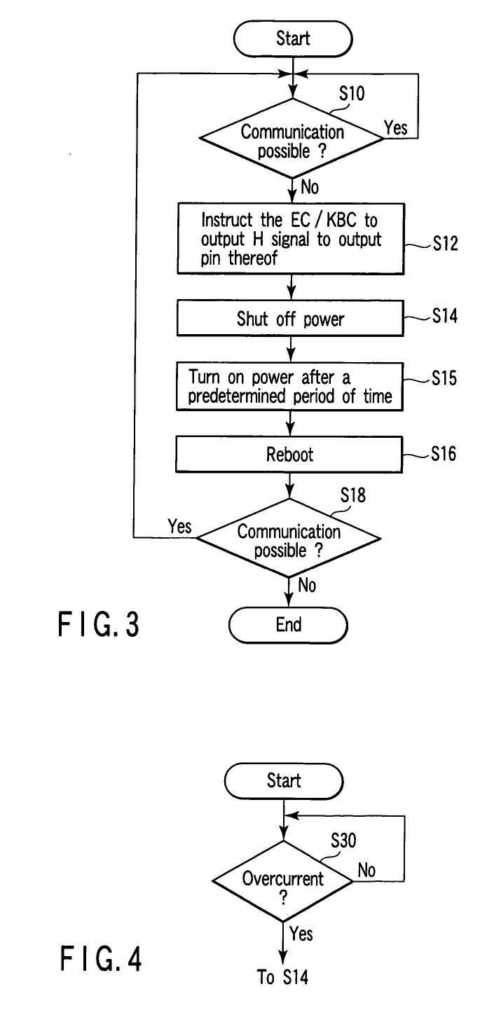

FIG. 3 is a flowchart illustrating a method of controlling information processing to which information processing according to the present invention is applied.

The CPU 201 monitors the communication state with the fingerprint sensor 21 through the chip set 202. In step S10, the CPU 201 determines whether communication with the fingerprint sensor 21 is possible (whether the communication state is normal). If it is determined in step S10 that the communication is impossible, the CPU 201 instructs in step S12 the EC/KBC 211 to issue an H output signal (communication state abnormal signal) to an output pin thereof. In step S14, the OR circuit 222 receives the H output signal, and shuts off the power to the fingerprint sensor 21 by the power supply SW 214. After the power supply to the fingerprint sensor 21 is shut off and a predetermined period of time has passed, the CPU 201 instructs in step S15 the EC/KBC 211 to issue an L output signal (communication state normal signal) to the output pin of the EC/KBC 211. In response to the L output signal, the OR circuit 222 turns on the power to the fingerprint sensor 21 by using the power supply SW 214. Next, in step S16, the computer 10 reboots. Then, in step S18, the CPU 201 determines again whether communication with the fingerprint sensor 21 is possible (whether the communication state is normal). In response to a power-on signal, the fingerprint sensor initializing circuit 223 initializes and starts the fingerprint sensor 21.

FIG. 4 is a flowchart illustrating the method of controlling information processing based on a signal from the overcurrent detecting circuit 21a of the fingerprint sensor 21.

In step S30, if the overcurrent detecting circuit 21a of the fingerprint sensor 21 detects an overcurrent (or abnormality in circuit), the overcurrent detecting circuit 21a transmits an H output (overcurrent detection) signal to the EC/KBC 211. Thereafter, the apparatus goes to the step S14, and shuts off the power to the fingerprint sensor 21 in the same manner as the above processing. To enhance safety, the OR circuit 222 is set to shut off the power to the fingerprint sensor 21 by the power SW 214, if it receives an H output signal being a signal indicating an abnormal communication state from one of the EC/KBC211 and the overcurrent detecting circuit 21a of the fingerprint sensor 21. As a matter of course, it may be set to shut off the power to the fingerprint sensor 21 in response to H output signals from both the EC/KBC 211 and the overcurrent detecting circuit 21a of the fingerprint sensor 21. Further, the OR circuit is set to turn on the power to the fingerprint sensor 21 when it receives L output signals (normal signal) from both the EC/KBC 211 and the overcurrent detecting circuit 21a of the fingerprint sensor 21, to enhance safety. However, as a matter of course, it is possible to provide a setting of turning on the power to the fingerprint sensor 21 in response to an L output signal from one of the EC/KBC 211 and the overcurrent detecting circuit 21a of the fingerprint sensor 21.

In the processing of shutting off the power to the fingerprint sensor 21, the CPU 201 can make the LED indicator 220 being indication means illuminate (or blink) with a red light, for example, or display a notice of an abnormal state of the fingerprint sensor 21 on the LCE display screen 121.

According to the above structure, it is possible to safely shut off the fingerprint sensor, even if an overcurrent is detected in hardware or circuit abnormality occurs, and it is possible to provide a system with a high reliability.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
internal storage means;
a fingerprint sensor which detects a fingerprint image; and
monitoring control means for monitoring a communication state between a program stored in the internal storage means and the fingerprint sensor,
wherein the monitoring control means shuts off power to the fingerprint sensor if the monitoring control means determines that the communication state is abnormal.

2. An information processing apparatus according to claim 1, wherein
the fingerprint sensor has overcurrent detecting means, and the monitoring control means shuts off the power to the fingerprint sensor if the overcurrent detecting means detects abnormality.

3. An information processing apparatus according to claim 1, wherein
the program is an application and/or a BIOS program stored in the internal storage means.

4. An information processing apparatus according to claim 1, further comprising:
indication means for indicating information from the monitoring control means,
wherein the indication means indicates an abnormal state if the monitoring control means detects abnormality.

5. An information processing apparatus according to claim 2, further comprising:
indication means for indicating information from the monitoring control means,
wherein the indication means indicates an abnormal state if the monitoring control means detects abnormality.

6. An information processing apparatus according to claim 1, wherein
if the power to the fingerprint sensor is shut off by the monitoring control means, the monitoring control means starts the fingerprint sensor if the monitoring control means determines that detection information from the overcurrent detecting means and the communication state are normal.

7. An information processing apparatus according to claim 2, wherein
if the power to the fingerprint sensor is shut off by the monitoring control means, the monitoring control means starts the fingerprint sensor if the monitoring control means determines that detection information from the overcurrent detecting means and the communication state are normal.

8. A method of controlling an information processing apparatus comprising internal storage means and a fingerprint sensor which detects a fingerprint image, the method comprising:
a monitoring control monitoring a communication state between a program stored in the internal storage means and the fingerprint sensor; and
a power control shutting off power to the fingerprint sensor if it is determined in the monitoring control that the communication state is abnormal.

9. A method according to claim 8, wherein
the fingerprint sensor has overcurrent detecting means, and the power to the fingerprint sensor is shut off if the overcurrent detecting means detects abnormality.
